(19) United States
(12) Patent Application Publication
(10) Pub. No.: US 2011/0101614 A1
(43) Pub. Date: May 5, 2011

(54) Seal Unit and Related Methods

(75) Inventor: Vincent Raillard, Bassens (FR)

(73) Assignee: Soletanche Freyssinet, Reil Maimaison (FR)

(21) Appl. No.: 13/001,309

(22) PCT Filed: Jun. 25, 2009
(86) PCT No.: PCT/FR09/51211

§ 371 Date: Dec. 23, 2010

(30) Foreign Application Priority Data
Jun. 26, 2008 (FR) 08 54286

(51) Int. Cl. E04B 1/682; F16J 15/06

(52) U.S. Cl. 277/316; 277/630

(57) ABSTRACT

The invention Mates to a seal unit (4) for providing a seal between two construction elements (1;2). Said seal unit includes a sealing material (5) capable of reversibly deforming and means (6-9) for exerting a controlled compression on the sealing material so as to cause the corresponding deformation of the sealing material, substantially transverse to the compression.

The present invention concerns a seal unit.

Many applications necessitate the provision of a seal between two construction elements.

For example, it is known to provide a seal around slabs closing an opening formed in a concrete layer such as a wall, a floor or a ceiling providing access to a space containing machines (motors, pumps, etc.) or to any other sensitive area. In this way, in functional operation, water that may be in contact with the slabs does not penetrate to the interior of said space or the sensitive area.

Such a seal is generally obtained by placing seals in the interstices that exist on the one hand between the adjacent slabs and on the other hand between the slabs and the concrete layer. The seals are most often formed in situ, for example by applying in the interstices a sealing material in a not totally solidified state.

If access to the space or sensitive area is necessary, for example to carry out maintenance operations therein, the seals must be destroyed to be able to remove the slabs and uncover the opening.

To revert to the functional operation mode, the slabs are again placed over the opening and new seals are placed around the slabs.

These operations are repeated as many times as necessary.

Such a process, which imposes the destruction of the existing seals on each removal of the slabs as well as the fabrication and placing of new seals each time the slabs are replaced, entails a high cost.

From an environmental point of view, it furthermore generates a very significant quantity of waste. Thus, for the seals used in French nuclear power stations alone, the annual quantity of waste may be evaluated at more than one hundred tonnes.

One object of the present invention is to provide a seal between two construction elements in a manner likely to limit the costs and the quantity of waste produced.

Thus the invention proposes a seal unit intended to provide a seal between two construction elements. The seal unit includes a sealing material capable of reversibly deforming and means for exerting a controlled compression on the sealing material so as to cause corresponding deformation of the sealing material substantially transversely to the compression.

By virtue of its construction, such a seal unit may be very easily installed between the two construction elements. It may also be easily removed therefrom. Re-use, possibly multiple re-use, of the seal unit is therefore possible.

The costs linked to a series of alternating associations and liberations of the construction elements with the aid of this seal unit are thus reduced compared to the traditional process outlined in the introduction, likewise the resulting quantity of waste.

According to advantageous embodiments of the invention that may be combined in any feasible manner:

the means for exerting a controlled compression on the sealing material include a first element and a second element respectively in contact with opposite edges of the sealing material and at least one intermediate element able to control the distance between said first and second elements;
the intermediate element comprises at least one internally threaded part placed inside the sealing material and fixed to the first element and at least one externally threaded part cooperating with the internally threaded part and the head of which projects from the sealing material beyond the second element;
the seal unit further includes a plate intended to bear on the two construction elements and surmounting the sealing material and/or at least a portion of the means for exerting a controlled compression on the sealing material;
the plate is disposed in contact with the second element and the externally threaded part passes through the plate;
the sealing material comprises a silicone elastomer;
the sealing material also has a fire retardant property;
the sealing material is adapted to be decontaminated following contamination by radiation; and/or
the sealing material conforms to specifications for products and materials usable in power stations.

The invention also proposes a seal unit intended to provide a seal between two construction elements, the seal unit including a sealing material capable of reversibly deforming and means for exerting a controlled compression on the sealing material so as to cause corresponding deformation of the sealing material substantially transversely to the compression. In this seal unit the means for exerting a controlled compression on the sealing material include a first element and a second element respectively in contact with opposite edges of the sealing material and at least one intermediate element able to control the distance between said first and second elements. Furthermore, the intermediate element comprises at least one internally threaded part placed inside the sealing material and fixed to the first element and at least one externally threaded part cooperating with the internally threaded part and the head of which projects from the sealing material beyond the second element.

The invention also proposes a method of fabrication of any of the seal units referred to above. This method comprises the following steps:
obtaining means for exerting a controlled compression on a sealing material;
placing the sealing material in the liquid or viscous state relative to said means for exerting a controlled compression on the sealing material so that said means for exerting a controlled compression on the sealing material are able to bring about corresponding deformation of the sealing material substantially transversely to the compression when the sealing material is in the solid state;
allowing the sealing material to dry until it solidifies.

The invention further proposes a method for providing a seal between two construction elements with the aid of any of the seal units referred to above. This method comprises the following steps:
placing the seal unit between the two construction elements, the means for exerting a controlled compression on the sealing material being accessibly disposed so that they can be activated by an operator;
activating the means for exerting a controlled compression on the sealing material so that the sealing material enters into contact with the two construction elements by deformation.

The invention further proposes a method for separating two construction elements previously connected by any of the seal units referred to above. This method comprises the following steps:
activating the means for exerting controlled compression on the sealing material so as to reduce the compression exerted on the sealing material;
removing the seal unit when the sealing material is no longer in contact with the two construction elements.

Other features and advantages of the present invention will become apparent in the description of nonlimiting embodiments given hereinafter with reference to the appended drawings, in which:

FIG. 1 is a diagram showing construction elements between which a seal unit of the invention may be installed;

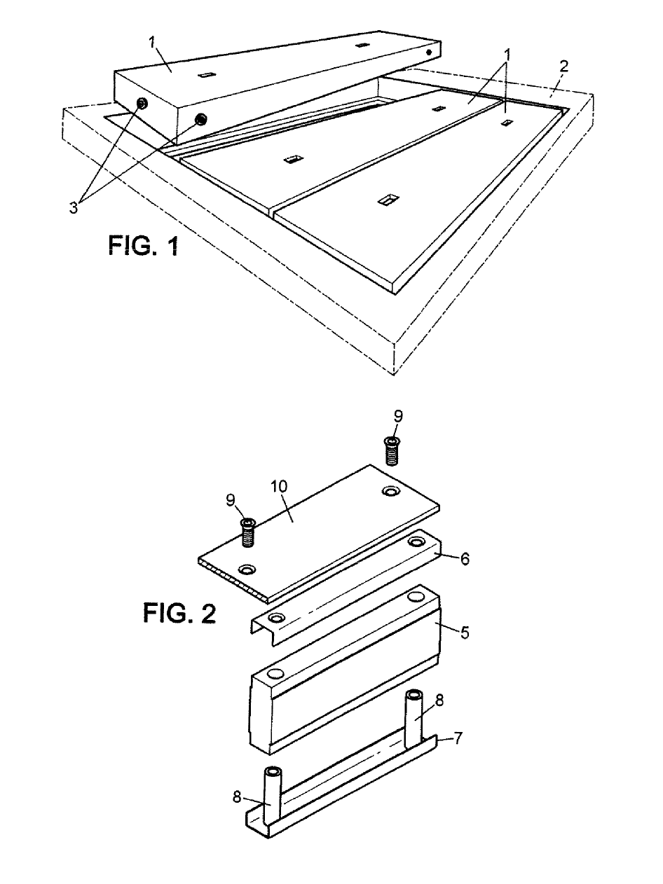

FIG. 2 is an exploded view showing the components of one example of a seal unit of the invention;

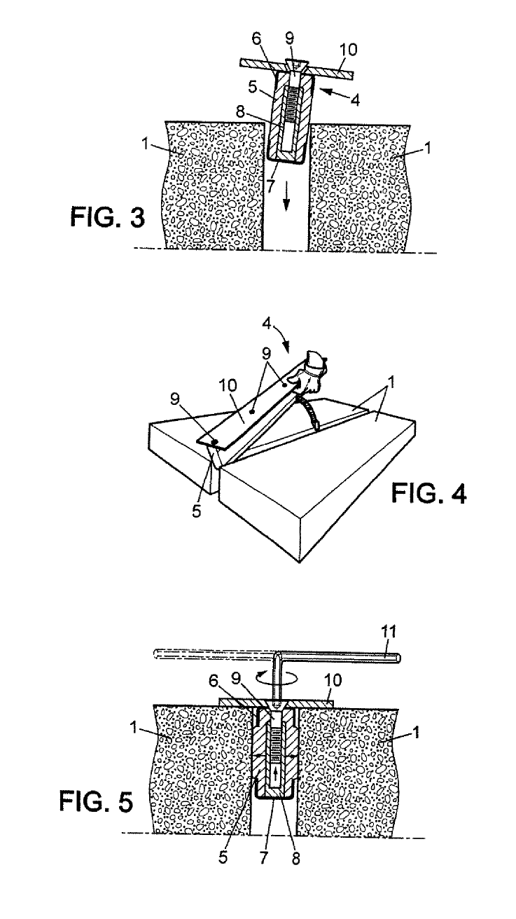

FIG. 3 is a part-sectional view of one example of a seal unit of the invention during its introduction between construction elements;

FIG. 4 is a perspective view of one example of a seal unit of the invention during its introduction between construction elements;

FIG. 5 is a part-sectional view of one example of a seal unit of the invention during compression of the sealing material that it incorporates;

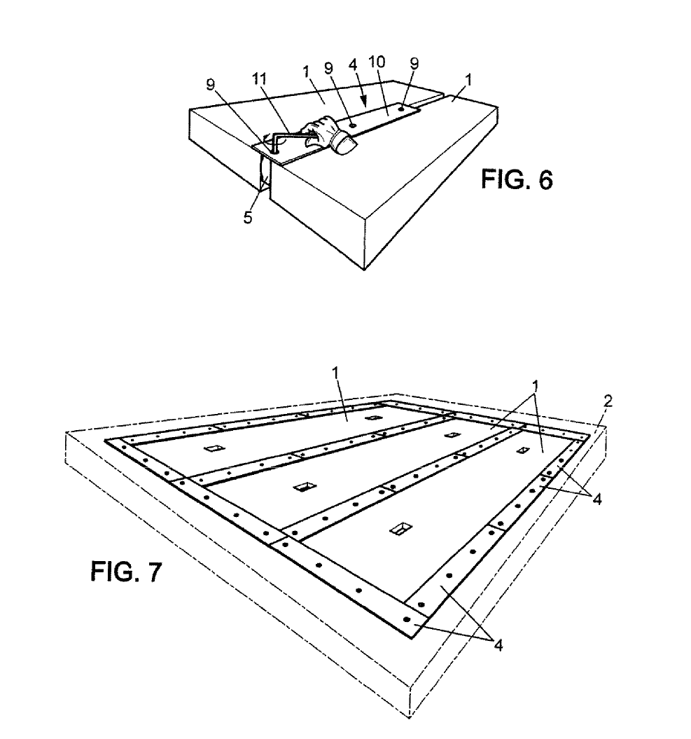

FIG. 6 is a perspective view of one example of a seal unit of the invention during compression of the sealing material that it incorporates;

FIG. 7 is a diagram showing the construction elements from FIG. 1 sealed by means of a plurality of seal units of the invention;

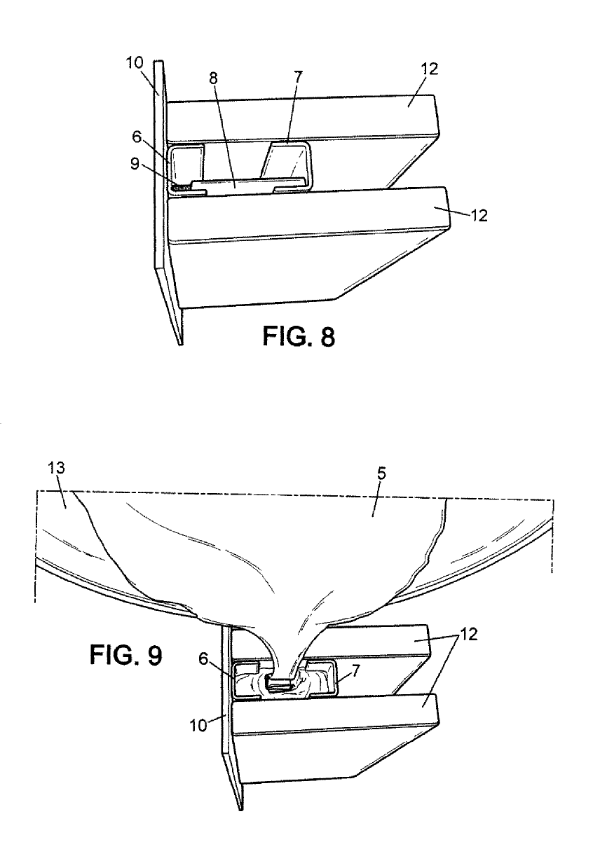

FIGS. 8 and 9 illustrate successive steps of the fabrication of one example of a seal unit of the invention.

The invention proposes a seal unit intended to provide a seal between two construction elements.

The construction elements in question may be of any kind that may be envisaged. By way of example, as shown in FIG. 1, they may be slabs 1 placed alongside each other to close an opening formed in a concrete layer 2 (which itself constitutes a construction element).

The layer 2 forms the floor of an upper space and the ceiling of a lower space, for example. Access to the lower space from the upper space is thus possible only in the absence of the slabs 1. The lower space may for example consist of a room containing machines (motors, pumps, etc.) the operation of which may be degraded by contact with water or any other sensitive area (room within a nuclear power station, etc.). Conversely, the upper space is for example an area liable to contain water.

In a functional operation mode, the slabs 1 close the access to the lower space. To this end, metal abutments 3 may be fixed to lateral edges of the slabs 1 to rest on a rib disposed all around the internal surface of the opening formed in the concrete layer 2.

To provide a seal between two adjacent slabs 1 or between a slab 1 and the concrete layer 2 one or more seal units are used.

FIG. 2 is an exploded view showing the various components of one example of a seal unit of the invention. In this example, the seal unit comprises a sealing material 5 adapted to deform reversibly.

The dimensions of this sealing material 5 may be chosen as a function of the seal required between the two construction elements concerned. For example, if the two construction elements are adjacent slabs 1, as shown in FIG. 1, the width of the unstressed sealing material 5 is advantageously chosen to be slightly less than the gap between the slabs. The length of the sealing material 5 may be less than or equal to that of the slabs 1 between which the seal unit must be placed.

The seal unit further includes means for exerting a controlled compression on the sealing material 5 so as to bring about corresponding deformation of this material substantially transversely to the compression. When activated, these means thus make it possible to compress the sealing material 5 with a required intensity or to release the compression exerted on this sealing material, as required.

In the FIG. 2 example, these means comprise a first element 7 intended to come into contact with a lower edge of the sealing material 5 and a second element 6 intended to come into contact with an upper edge of the sealing material 5.

The elements 6 and 7 advantageously have a shape complementary to that of the respective edges of the sealing material 5 with which they are intended to come into contact. They are for example sections with a cross section that is substantially U-shaped, as shown in FIG. 2.

These means further comprise an intermediate element adapted to control the distance between the elements 6 and 7. In the FIG. 2 example, two intermediate elements are disposed at opposite ends of the sealing material 5. These intermediate elements each consist of an internally threaded part 8 fixed to the bottom element 7 and intended to be placed in corresponding holes in the sealing material 5 and an externally threaded part such as a screw 9 cooperating with the internally threaded part 8 and the head of which projects from the sealing material 5 beyond the top element 6.

The seal unit from FIG. 2 optionally further includes a plate 10 on top of the sealing material 5 and the top element 6 in contact with which it is intended to be placed. In this case, the screws 9 also pass through the plate 10 to be able to cooperate with the corresponding threaded parts 8. The plate 10 is for example a galvanized or non-slip tread plate in stainless steel or any other material that may be envisaged. It will be noted that in the absence of the element 6, the plate 10 could be directly on top of the sealing material 5.

The use of the seal unit described with reference to FIG. 2 will be more particularly described hereinafter.

As shown in FIGS. 3 and 4, the seal unit 4 is introduced between the construction elements concerned, as it happens between adjacent slabs 1 in this example. This introduction is made possible by the fact that the sealing material 5 has been sized to have a width slightly less than the gap between the slabs 1. When the seal unit comprises a plate 10 on top of the sealing material 5 and the top element 6, the introduction of the seal unit 4 between the slabs 1 is complete when this plate 10 bears on each of the slabs 1. This seal unit is preferably positioned equidistantly from the slabs 1.

In this example, when the seal unit 4 is placed between the slabs 1, the means for exerting a controlled compression on the sealing material 5 are accessible for an operator situated above the slabs 1. The screws 9 may be tightened or loosened from the exterior side of the slabs 1.

Once the seal unit 4 has been placed between the slabs 1, the sealing material 5 is compressed by tightening the screws 9, for example with the aid of an appropriate key 11 (Allen key, etc.) as shown in FIGS. 5 and 6. This clamping has the effect of causing each screw 9 to enter progressively into the corresponding internally threaded part 8, drawing the latter upward. Each internally threaded part 8 being fixed to the bottom element 7, the latter is also moved upward and thus toward the top element 6.

This progressive reduction of the distance between the elements 6 and 7 compresses the sealing material 5 in the heightwise direction. The sealing material 5 reacts to this compression by deforming substantially transversely to the compression, i.e. in the direction of the slabs 1 with which it comes into contact.

The contact between the sealing material 5 and the slabs 1 becomes commensurately tighter as the sealing material 5 is compressed, within the limits of the deformation capacity of the seal material 5. Because of its sealing nature, the material 5 then prevents any water in contact with the upper surface of the slabs 1 passing below the sealing unit 4. Thus a seal is provided.

Using the top plate 10 furthermore makes it possible to provide surface continuity between the slabs 1, which authorizes the passage of persons and/or equipment on wheels over the slabs without damaging the sealing material 5 protected by the plate 10, for example.

FIG. 7 shows the slabs 1 in position in the concrete layer 2 and surrounded by a plurality of seal units 4 that have been placed as indicated above. A seal is thus provided over the whole of the area, including at the junctions between two seal units at which the respective sealing materials come into contact with each other. In this configuration, any water flowing over the layer 2 and the slabs 1 would be prevented from penetrating into the lower space.

An important advantage of the seal unit that has just been described is its capacity to be removable and reusable.

The sealing unit 4 is removed by operations that are the opposite of those described above. Accordingly, referring to FIGS. 5 and 6, loosening each screw 9, for example with the aid of the same key that previously made it possible to tighten these screws, makes it possible to reduce progressively the compression exerted on the sealing material 5. Because of the reversibility of the deformation of the sealing material 5, sufficient loosening of the screws 9 results in a loss of contact between the sealing material 5 and the slabs 1, which authorizes removal of the seal unit 4.

Once all the seal units around the slabs 1 have been removed, these slabs 1 are separated and can therefore be removed to uncover the opening providing access to the lower space, for example to carry out materials handling operations therein.

To revert to the functional operation mode, the slabs 1 may be replaced so as to shut off access to the lower space and the same seal units as were used before may be replaced around the slabs 1 to provide the seal.

The ability to remove the seal units 4 without destroying or damaging them and to be able to place them between the construction elements as many times as necessary makes it possible to avoid the fabrication and fitting of new seals each time the slabs are replaced. This mode of operation thus limits costs and the quantity of waste produced.

It will further be noted that the use of the seal units described above saves time when fitting them compared to traditional seals. In the prior art methods, the seal is fabricated in situ and necessitates some drying time before providing an effective seal. Conversely, the seal units of the invention may be prefabricated, so that the seal unit function is provided immediately after placing them between the construction elements.

An example of a method of fabrication of the seal units 4 described above is described in detail next with reference to FIGS. 8 and 9.

In this example, the elements 6 and 7, the internally threaded parts 8 fixed to the element 7 and the corresponding screws 9, which constitute the means for exerting a controlled compression on the sealing material 5, as well as the plate 10 when used, are assembled and advantageously placed, over the whole of their length, between two delimiter plates 12 that may be clamped together.

The sealing material 5 initially contained in a tank 13 in the liquid or viscous state is then poured until it fills the space situated between the elements 6 and 7 and the delimiter plates 12. During this pouring, the sealing material 5 comes to surround completely the internally threaded parts 8 and part of the screws 9. The sealing material 5 is then allowed to dry until it solidifies.

The sealing material 5 used is a silicone elastomer, for example. Its coefficient of deformation in compression is advantageously at least 25%. Its behavior is advantageously visco-elastic, which ensures that its deformation is reversible.

If the application in which it participates necessitates it, the sealing material 5 may further have a fire retardant property. In this case, this material will advantageously be chosen to be consumed slowly in contact with fire and to transmit heat relatively badly. For example, the material could be chosen not to exceed 140° C. at its surface when it is subjected to high heat.

In this way, the seal unit makes it possible to provide a fire retardant function between an upper space toward a lower space or vice versa. By the construction of such a seal unit, the metal parts having no face exposed to the fire (the plates 10 for example) are thermally insulated from the metal parts having a face exposed to the fire (the elements 7 for example) by the sealing and fire retardant material 5, thus limiting the thermal bridges between the location of the fire and that which must be protected.

When the seal unit must be placed in an area like to be contaminated by radiation, for example in a nuclear power station, a sealing material 5 that can be decontaminated is preferably chosen. In the case of contamination by radiation, it will then suffice to remove the seal unit as explained above, to decontaminate it using standard techniques, for example by washing it or applying a varnish, and then to replace it. To this end, a smooth, non-porous elastomer may be chosen. A material that is self-smoothing in air may equally be envisaged.

If required, a sealing material complying with the specifications for products and materials usable in power stations may advantageously be used.

It will be noted that the example of a seal unit 4 described with reference to the figures is not limiting on the invention. Many other examples of seal units may also be envisaged. In particular, the means for exerting a controlled compression on the sealing material may have a shape different from that described above, provided that these means enable deformation of the sealing material substantially transversely to the compression.

Similarly, if the means for exerting a controlled compression on the sealing material comprise two elements in contact with opposite edges of the sealing material and an intermediate element adapted to control the distance between these two elements, the intermediate element may have a structure different from an internally threaded part cooperating with an externally threaded part. For example, an intermediate element comprising a spring or a piston might be suitable.

Finally, in the example described above, the seal units aim to provide a seal around slabs placed on a horizontal concrete layer. Of course, other applications may also be envisaged in the context of the present invention. For example, the seal units could be placed between vertical, even non-linear walls. In the latter case, the shape of the seal units should advantageously follow that of the space between the walls into which they must be introduced.

As will be apparent to the person skilled in the art, the fabrication method described above will advantageously be adapted to these variants of the structure of the seal unit whilst continuing to conform to the principles of the invention.

1. Seal unit (4) intended to provide a seal between two construction elements (1;2), the seal unit including a sealing material (5) capable of reversibly deforming and means (6-9) for exerting a controlled compression on the sealing material so as to cause corresponding deformation of the sealing material substantially transversely to the compression, wherein the means (6-9) for exerting a controlled compression on the sealing material (5) include a first element (7) and a second element (6) respectively in contact with opposite edges of the sealing material and at least one intermediate element (8-9) able to control the distance between said first and second elements, and wherein the intermediate element (8-9) comprises at least one internally threaded part (8) placed inside the sealing material (5) and fixed to the first element (7) and at least one externally threaded part (9) cooperating with the internally threaded part and the head of which projects from the sealing material beyond the second element (6).

2. Seal unit (4) according to claim 1, further including a plate (10) intended to bear on the two construction elements (1,2) and surmounting the sealing material (5) and/or at least a portion of the means for exerting a controlled compression on the sealing material.

3. A seal unit (4) according to claims 1 and 2, where the plate (10) is disposed in contact with the second element (6) and wherein the externally threaded part passes through the plate.

4. A seal unit (4) according to any of the preceding claims, wherein the sealing material (5) comprises a silicone elastomer.

5. Seal unit (4) according to any of the preceding claims, wherein the sealing material (5) also has a fire retardant property.

6. Seal unit (4) according to any one the preceding claims, wherein the sealing material (5) is adapted to be decontaminated following contamination by radiation.

7. Seal unit (4) according to any of the preceding claims, wherein the sealing material (5) conforms to specifications for products and materials usable in power stations.

8. Method of fabrication of a seal unit (4) according to any of the preceding claims, comprising the following steps:
obtaining means (6-9) for exerting a controlled compression on a sealing material;
placing the sealing material (5) in the liquid or viscous state relative to said means for exerting a controlled compression on the sealing material so that said means for exerting a controlled compression on the sealing material are able to bring about corresponding deformation of the sealing material substantially transversely to the compression when the sealing material is in the solid state;
allowing the sealing material to dry until it solidifies.

9. Method for providing a seal between two construction elements (1,2) with the aid of a seal unit (4) according to any of claims 1 to 7, the method comprising the following steps:
placing the seal unit between the two construction elements, the means (6-9) for exerting a controlled compression on the sealing material being accessibly disposed so that they can be activated by an operator;
activating the means for exerting a controlled compression on the sealing material so that the sealing material enters into contact with the two construction elements by deformation.

10. Method for separating two construction elements (1,2) previously connected by a seal unit (4) by the method of claim 9, comprising the following steps:
activating the means (6-9) for exerting controlled compression on the sealing material (5) so as to reduce the compression exerted on the sealing material;
removing the seal unit when the sealing material is no longer in contact with the two construction elements.
